(19) United States
(12) Patent Application Publication
(10) Pub. No.: US 2026/0138606 A1
(43) Pub. Date: May 21, 2026

(54) VEHICLE CONTROL DEVICE, VEHICLE CONTROL METHOD, AND COMPUTER PROGRAM FOR VEHICLE CONTROL

(71) Applicant: TOYOTA JIDOSHA KABUSHIKI KAISHA, Toyota-shi Aichi-ken (JP)

(72) Inventor: Kenta Kumazaki, Bunkyo-ku Tokyo-to (JP)

(73) Assignee: TOYOTA JIDOSHA KABUSHIKI KAISHA, Toyota-shi Aichi-ken (JP)

(21) Appl. No.: 19/390,921

(22) Filed: Nov. 17, 2025

(30) Foreign Application Priority Data
Nov. 19, 2024 (JP) 2024-201511

(51) Int. Cl. B60W 30/14; B60W 40/08; G06V 20/59; G06V 40/18

(52) U.S. Cl. CPC B60W 30/146; B60W 40/08; G06V 20/59; G06V 40/18; B60W 2540/225; B60W 2554/4045; B60W 2554/4046

(57) ABSTRACT

A vehicle control device includes a processor configured to: detect another vehicle traveling in an adjacent lane adjacent to a host lane on which a host vehicle travels based on an exterior sensor signal, detect a relative behavior of the other vehicle with respect to the host vehicle, determine whether or not the relative behavior of the other vehicle satisfies a predetermined interruption determination condition, decelerate the host vehicle when the behavior satisfies the interruption determination condition, detect a gaze state of one or more occupants of the host vehicle with respect to the other vehicle based on the detection result of a gaze direction of the occupants of the host vehicle based on an interior image, and adjust the interruption determination condition according to the gaze state.

### CROSS-REFERENCE TO RELATED APPLICATIONS

This application claims priority to Japanese Patent Application No. 2024-201511 filed November 19, 2024, the entire contents of which are herein incorporated by reference.

### FIELD

The present disclosure relates to a vehicle control device, a vehicle control method, and a computer program for vehicle control.

### SUMMARY

A technique of controlling a host vehicle so that another vehicle and the host vehicle do not come too close to each other in a case where there is the other vehicle that is expected to cut in front of the host vehicle has been proposed (see Japanese Unexamined Patent Publication No. 2019-505034).

The above document describes that when a target vehicle traveling in a lane adjacent to a host lane on which a host vehicle is traveling tries to cut into the host lane, cutting in by the target vehicle is avoided by changing the speed, acceleration of the host vehicle, and/or moving the host vehicle into another lane. Furthermore, the above document describes avoiding frequent unnecessary braking and/or acceleration when the target vehicle appears to cut in but does not actually cut in. To avoid this, the sensitivity to cutting in attempts is changed based on static road features such as lane end or road segmentation, dynamic road features such as the presence of other vehicles in front of the host vehicle that may try to cut in, and/or traffic rules and driving habits within the geographic area.

When the behavior of the host vehicle with respect to the behavior of the other vehicle that may cut in front of the host vehicle is different from that predicted by the occupant of the host vehicle, the occupant may feel anxious.

Therefore, it is an object of the present disclosure to provide a vehicle control device capable of making it difficult for an occupant of a host vehicle to feel anxiety with respect to the behavior of the host vehicle when there is another vehicle that may cut in front of the host vehicle.

According to one embodiment, a vehicle control device is provided. The vehicle control device includes a processor configured to: detect another vehicle traveling on an adjacent lane adjacent to a host lane on which a host vehicle travels based on an exterior sensor signal representing a predetermined area around the host vehicle, detect a relative behavior of the other vehicle with respect to the host vehicle, determine whether or not the relative behavior of the other vehicle satisfies a predetermined interruption determination condition, decelerate the host vehicle when the behavior satisfies the interruption determination condition, detect a gaze direction of one or more occupants of the host vehicle based on an interior image representing an interior of the host vehicle, detect a gaze state of the occupants with respect to the other vehicle based on a detection result of the gaze direction, and adjust the interruption determination condition according to the gaze state.

In one embodiment, the processor relaxes the interruption determination condition as a duration in which a driver among the occupants is gazing at the other vehicle becomes longer.

In one embodiment, the processor relaxes the interruption determination condition as the number of the occupants of the host vehicle who are gazing at the other vehicle increases.

According to another embodiment, a vehicle control method is provided. The vehicle control method includes: detecting another vehicle traveling on an adjacent lane adjacent to a host lane on which a host vehicle travels based on an exterior sensor signal representing a predetermined area around the host vehicle; detecting a relative behavior of the other vehicle with respect to the host vehicle; detecting the relative behavior of the other vehicle relative to the host vehicle; determining whether or not the relative behavior of the other vehicle satisfies a predetermined interruption determination condition; decelerating the host vehicle when the behavior satisfies the interruption determination condition; detecting a gaze direction of one or more occupants of the host vehicle based on an interior image representing an interior of the host vehicle; detecting a gaze state of the occupants with respect to the other vehicle based on a detection result of the gaze direction; and adjusting the interruption determination condition according to the gaze state.

According to still another embodiment, a non-transitory recording medium that stores a computer program for vehicle control is provided. The computer program includes instructions for causing a processor mounted on a host vehicle to execute a process including: detecting another vehicle traveling on an adjacent lane adjacent to a host lane on which the host vehicle travels based on an exterior sensor signal representing a predetermined area around the host vehicle; detecting a relative behavior of the other vehicle with respect to the host vehicle; detecting the relative behavior of the other vehicle relative to the host vehicle; determining whether or not the relative behavior of the other vehicle satisfies a predetermined interruption determination condition; decelerating the host vehicle when the behavior satisfies the interruption determination condition; detecting a gaze direction of one or more occupants of the host vehicle based on an interior image representing an interior of the host vehicle; detecting a gaze state of the occupants with respect to the other vehicle based on a detection result of the gaze direction; and adjusting the interruption determination condition according to the gaze state.

The vehicle control device according to the present disclosure has an advantageous effect of being able to make it difficult for an occupant of a host vehicle to feel anxiety with respect to the behavior of the host vehicle when there is another vehicle that may cut in front of the host vehicle.

### BRIEF DESCRIPTION OF DRAWINGS

FIG. 1 schematically illustrates the configuration of a vehicle control system equipped with a vehicle control device.

FIG. 2 illustrates the hardware configuration of an electronic control unit, which is an embodiment of the vehicle control device.

FIG. 3 is a functional block diagram of a processor of the electronic control unit, related to a vehicle control process.

FIG. 4 is a diagram for explaining an outline of a vehicle control process according to the present embodiment.

FIG. 5 is an operation flowchart of the vehicle control process.

### DESCRIPTION OF EMBODIMENTS

Hereinafter, a vehicle control device, a vehicle control method executed on the vehicle control device, and a computer program for vehicle control will be described with reference to the drawings. The vehicle control device detects a relative behavior of another vehicle traveling on an adjacent lane adjacent to a host lane on which a host vehicle travels with respect to the host vehicle. When the relative behavior of the other vehicle satisfies predetermined interruption determination condition, the vehicle control device controls the host vehicle so that a distance between the other vehicle and the host vehicle is maintained at a predetermined distance or more even if the other vehicle moves to the host lane in front of the host vehicle. At this time, the vehicle control device adjusts the interruption determination condition in accordance with the gaze state for the other vehicle by the occupant of the host vehicle.

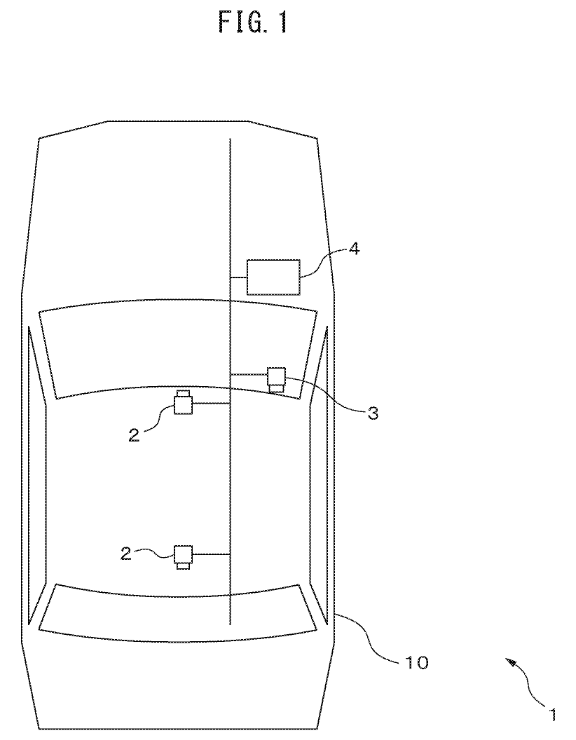

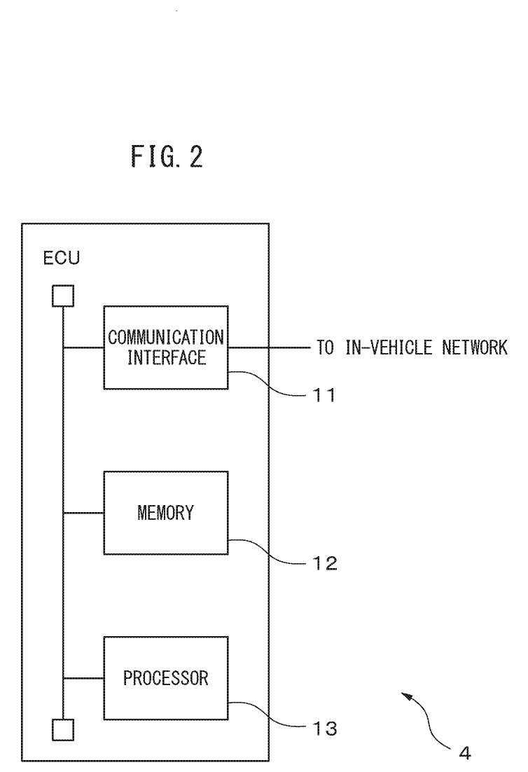

FIG. 1 schematically illustrates the configuration of a vehicle control system equipped with a vehicle control device. FIG. 2 illustrates the hardware configuration of an electronic control unit, which is an embodiment of the vehicle control device. In the present embodiment, the vehicle control system 1 mounted on the vehicle 10, which is an example of the host vehicle, and controlling the vehicle 10 includes at least exterior sensor 2, an in-vehicle monitor camera 3, and an electronic control unit (ECU) 4, which is an example of the vehicle control device. The one or more exterior sensors 2, the in-vehicle monitor camera 3, and the ECU 4 are communicably connected to each other via an in-vehicle network. The vehicle control system 1 may further include a wireless communication terminal (not shown) for communicating with other devices. Furthermore, the vehicle control system 1 may include a positioning device (not shown) that measures the position of the vehicle 10 in accordance with a satellite-based positioning system, such as a GPS receiver.

Each of the exterior sensors 2 is a sensor for detecting a situation around the vehicle 10, and is, for example, a camera or a range sensor such as a radar or a LiDAR. Note that the vehicle 10 may be provided with a plurality of exterior sensors having different detection ranges or different types. In FIG. 1, two exterior sensors 2 (an exterior sensor having a detection range in front of the vehicle 10 and an exterior sensor having a detection range in rear of the vehicle 10) are illustrated. In the present embodiment, a plurality of exterior sensors 2 having different detection ranges are provided in the vehicle 10 so as to be able to detect the entire periphery of the vehicle 10. Each of the exterior sensors 2 generates an exterior sensor signal representing a status of a predetermined detection area around the vehicle 10 at predetermined intervals, and outputs the generated exterior sensor signal to the ECU 4.

The in-vehicle monitor camera 3 is an example of an interior sensor, and is mounted toward the vehicle interior in front of the vehicle interior so that each occupant of the vehicle 10 including the driver is included in the imaging target area. The in-vehicle monitor camera 3 may include a light source such as an infrared LED. Then, the in-vehicle monitor camera 3 generates an image (hereinafter, referred to as an interior image) in which the occupant of the vehicle 10 is represented by capturing the imaging target area in the vehicle every predetermined imaging cycle, and outputs the generated interior image to the ECU 4. Note that the vehicle 10 may be provided with a plurality of in-vehicle monitor cameras 3 each having a different seat as an imaging target area.

The ECU 4 executes autonomous driving control of the vehicle 10 or executes driving support for the driver of the vehicle 10. In particular, when it is predicted that another vehicle traveling in the adjacent lane will move to the host lane in front of the vehicle 10, the ECU 4 decelerates the vehicle 10 so as to keep a distance between the other vehicle and the vehicle 10 at a predetermined distance or more by decelerating the vehicle 10.

As illustrated in FIG. 2, the ECU 4 includes a communication interface 11, a memory 12, and a processor 13. The communication interface 11, the memory 12, and the processor 13 may each be configured as separate circuits or may be integrally configured as a single integrated circuit.

The communication interface 11 includes an interface circuit for connecting the ECU 4 to the in-vehicle network. Each time the exterior sensor signal is received from any of the exterior sensor2 2, the communication interface 11 passes the received exterior sensor signal to the processor 13. The communication interface 11 passes the received interior image to the processor 13 each time the interior image is received from the in-vehicle monitor camera 3.

The memory 12 is an example of a storage unit, and includes, for example, a volatile semiconductor memory and a non-volatile semiconductor memory. The memory 12 stores various types of data used in the vehicle control process executed by the processor 13. For example, the memory 12 stores various parameters of each exterior sensor 2 (for example, a focal length, an imaging direction, its mounted position, and the like) and various parameters for specifying a classifier for detecting an object around the vehicle 10. Further, the memory 12 stores various kinds of information used for detection of a gaze direction of the occupant and determination of gaze with respect to another vehicle. Further, the memory 12 temporarily stores each exterior sensor signal and each interior image. Further, the memory 12 temporarily stores various types of data generated during the vehicle control process.

The processor 13 includes one or more central processing units (CPUs) and a peripheral circuit thereof. The processor 13 may further include another operating circuit, such as a logic-arithmetic unit, an arithmetic unit, or a graphics processing unit. Then, the processor 13 executes a vehicle control process for the vehicle 10.

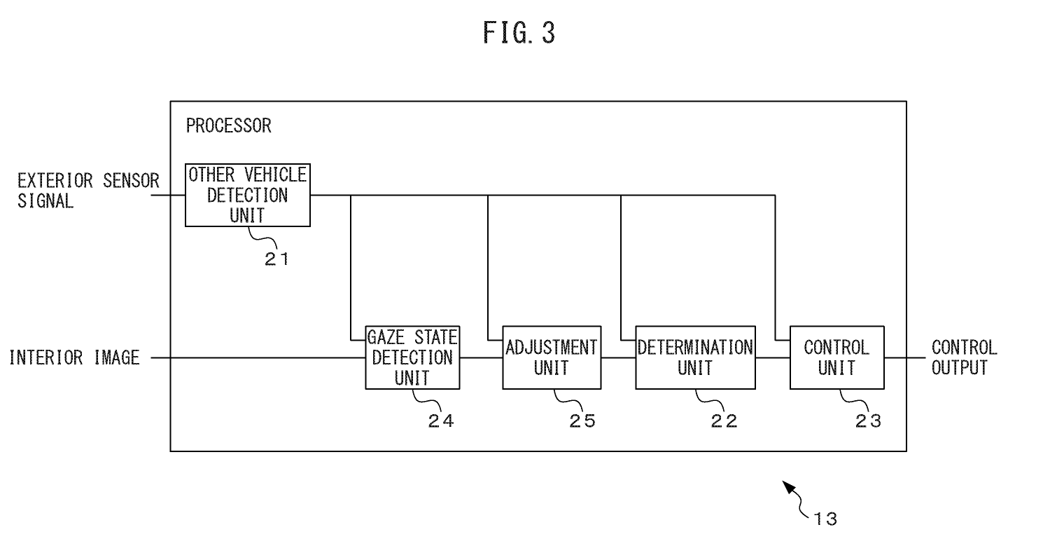

FIG. 3 is a functional block diagram of the processor 13 related to the vehicle control process. The processor 13 includes the other vehicle detection unit 21, the determination unit 22, the control unit 23, the gaze state detection unit 24, and the adjustment unit 25. Each of these units included in the processor 13 is a functional module implemented by a computer program executed by the processor 13. Alternatively, each of these units may be a dedicated operating circuit provided in the processor 13.

The other vehicle detection unit 21 detects one or more other vehicles traveling in adjacent lane adjacent to the host lane. When the other vehicle traveling in the adjacent lane is detected, the other vehicle detection unit 21 detects the relative behavior of the other vehicle with respect to the vehicle 10. Hereinafter, the other vehicle traveling in the adjacent lane may be referred to as a target vehicle for convenience of explanation.

For example, the other vehicle detection unit 21 detects the other vehicle by inputting an exterior sensor signal generated by individual of the exterior sensors 2 to a classifier trained in advance so as to detect the other vehicle. The classifier is configured as a deep neural network (DNN) having a convolutional neural network (CNN) type architecture or attention mechanisms. Alternatively, the classifier may be configured as a classifier based on a machine learning algorithm other than DNN, such as a support vector machine. The classifier for detecting the other vehicle may be further configured to identify the type of the other vehicle. Types of other vehicles to be identified include an ordinary vehicle, a large vehicle such as a bus or a truck, and an emergency vehicle such as an ambulance, a fire engine or a police vehicle. In addition, the classifier for detecting the other vehicle may be configured to further identify a lighting state of the warning light included in the detected emergency vehicle.

Further, in a case where the exterior sensor 2 is a camera, the other vehicle detection unit 21 may detect a lane division line by inputting an exterior image, which is an example of the exterior sensor signal generated by the camera, to a classifier trained in advance so as to detect the lane division line. The classifier for detecting a lane division line is also configured as a DNN with a CNN type architecture or attention mechanism. Note that one classifier may be trained in advance so as to detect both the other vehicle and the lane division line.

The other vehicle detection unit 21 identifies, as the target vehicle, the other vehicle traveling in the adjacent lane among the detected other vehicles. When the exterior sensor signal is an exterior image, the other vehicle detection unit 21 specifies the lane division line closest to the vehicle 10 as the host lane division line that divides the host lane. The other vehicle detection unit 21 compares the position of the lower end of the object region in which the detected other vehicle is represented on the exterior image is represented with the position of the host lane division line. When the lower end of the object region is located farther from the vehicle 10 than the host lane division line and is located closer to the vehicle 10 than the other lane division line adjacent to the host lane division line, the other vehicle detection unit 21 identifies the other vehicle represented in the object region as the target vehicle. In addition, in a case where the exterior sensor signal is a ranging signal generated by a range sensor that is an example of the exterior sensor 2, the other vehicle detection unit 21 obtains a distance (hereinafter, referred to as a lateral distance) between the vehicle 10 and the other vehicle in a direction orthogonal to the traveling direction of the vehicle 10 (hereinafter, referred to as a lateral direction) based on a distance and an azimuth to the other vehicle detected on the ranging signal. When the lateral distance to the other vehicle is within a range (for example, 1 to 3m) corresponding to the distance between two vehicles traveling in lanes adjoining each other, the other vehicle detecting unit 21 identifies the other vehicle as the target vehicle.

The other vehicle detection unit 21 determines the relative behavior of the target vehicle with respect to the vehicle 10. In the present embodiment, the other vehicle detection unit 21 obtains the relative speed of the target vehicle with respect to the vehicle 10, the distance between the vehicle 10 and the target vehicle along the traveling direction of the vehicle 10 (hereinafter, referred to as a vertical distance), and the relative positional relationship between the vehicle 10 and the target vehicle as index values representing the relative behavior.

For this purpose, the other vehicle detecting unit 21 tracks the target vehicle by applying a predetermined tracking method such as ByteTrack to the target vehicle detected from each of the plurality of exterior sensor signals obtained in time series. The other vehicle detection unit 21 obtains the vertical distance to the tracked target vehicle and the relative position between the tracked target vehicle and the vehicle 10 at the time of acquiring each exterior sensor signal. Further, the other vehicle detection unit 21 obtains the relative speed of the target vehicle with respect to the vehicle 10 based on the time change of the vertical distance and the acquisition interval of the exterior sensor signal. When the exterior sensor signal is an exterior image, the lower end of the object region in which the target vehicle is represented corresponds to a position where the target vehicle is on the road surface. Further, the position of each pixel in the exterior image corresponds to the orientation viewed from the camera in a one-to-one manner. Therefore, the other vehicle detection unit 21 can determine the azimuth and distance from the vehicle 10 to the target vehicle based on the parameters of the camera, which is the exterior sensor 2 (the installation height, the imaging direction, the angle of view, and the like), and the position of the lower end of the object region in which the target vehicle is represented on the exterior image. In addition, when the exterior sensor is a ranging signal, the other vehicle detection unit 21 can determine the azimuth in which the target vehicle is represented on the ranging signal as the azimuth from the vehicle 10 to the target vehicle, and can determine the measured value of the distance with respect to the azimuth as the distance from the vehicle 10 to the target vehicle. The other vehicle detection unit 21 determines the azimuth and the distance from the vehicle 10 to the target vehicle as an index value representing the relative position of the target vehicle with respect to the vehicle 10. Further, the other vehicle detection unit 21 can determine the vertical distance between the vehicle 10 and the target vehicle based on the azimuth and the distance from the vehicle 10 to the target vehicle.

The other vehicle detection unit 21 calculates the relative speed of the target vehicle with respect to the vehicle 10 by dividing the amount of change in the vertical distance between the target vehicle and the vehicle 10 based on each of the two exterior sensor signals obtained most recently by the acquisition interval of the two exterior sensor signals.

In a case where a plurality of target vehicles are detected, the other vehicle detection unit 21 may execute tracking processing to track each target vehicle, and determine each index value representing a relative behavior for each tracked target vehicle.

The other vehicle detection unit 21 notifies the determination unit 22, the control unit 23, and the gaze state detection unit 24 of each index value each time the index value (relative speed, vertical distance, and relative position) indicating the relative behavior of the target vehicle with respect to the vehicle 10 is obtained. When the type of the target vehicle and the lighting state of the warning light are identified, the other vehicle detection unit 21 notifies the adjustment unit 25 of the identification result.

The determination unit 22 determines whether or not the index value representing the relative behavior of the target vehicle with respect to the vehicle 10 satisfies a predetermined interruption determination condition. Then, when the predetermined interruption determination condition is satisfied, the determination unit 22 determines that there is a possibility that the target vehicle may move from the adjacent lane to the host lane in front of the vehicle 10, that is, there is a possibility that the target vehicle may cut in front of the vehicle 10.

In the present embodiment, the interruption determination condition is that the relative speed of the target vehicle with respect to the vehicle 10 is higher than or equal to a predetermined speed threshold value, and the target vehicle approaches from the rear side of the vehicle 10 and the vertical distance is less than the predetermined distance threshold value. Note that the interruption determination condition is adjusted in accordance with the gaze state for the target vehicle by the occupant of the vehicle 10. The details of the adjustment of the interruption determination condition will be described later with respect to the adjustment unit 25.

When determining that the interruption determination condition is satisfied, the determination unit 22 notifies the control unit 23 of the determination result.

When the determination unit 22 notifies that the interruption determination condition is satisfied, the control unit 23 controls the powertrain or the brake of the vehicle 10 so as to decelerate the vehicle 10. Thus, the control unit 23 keeps the distance between the target vehicle and the vehicle 10 equal to or larger than a target distance even when the target vehicle cut in front of the vehicle 10. At this time, the control unit 23 sets the operating amount of the brake or the target torque for the powertrain so that the vehicle 10 decelerates at a preset deceleration. Note that a map representing the relationship between the deceleration, the behavior of the vehicle 10 (accelerator opening, shift position, speed, and the like), and the target torque and the operation amount of the brake is stored in advance in the memory 12. The control unit 23 may set the target torque and the operation amount of the brake with reference to the map. The control unit 23 controls the powertrain so as to achieve the set target torque, or operates the brake so as to achieve the set operation amount of the brake, thereby decelerating the vehicle 10. Then, the control unit 23 continues the deceleration of the vehicle 10 for a predetermined period (for example, several seconds), and stops the deceleration of the vehicle 10 after the predetermined period has elapsed. Note that, when the target vehicle is not moving to the host lane even after the predetermined period has elapsed, the control unit 23 may control the powertrain so that the speed of the vehicle 10 approaches the speed before deceleration. Similarly, even in a case where the distance between the target vehicle and the vehicle 10 is larger than the target distance after the target vehicle moves to the host lane in front of the vehicle 10, the control unit 23 may control the powertrain so that the speed of the vehicle 10 approaches the speed before deceleration. In addition, in a case where there is a space in which the vehicle 10 can enter an adjacent lane on the opposite side with respect to the adjacent lane where the target vehicle travels, the control unit 23 may control each unit of the vehicle 10 so as to move the vehicle 10 to the adjacent lane on the opposite side, instead of decelerating the vehicle 10.

The gaze state detection unit 24 detects the gaze direction of the driver of the vehicle 10 based on the interior image, and detects the gaze state of the driver with respect to the target vehicle based on the detected gaze direction. The driver is an example of an occupant of the vehicle 10. To this end, the gaze state detection unit 24 detects the gaze direction of the driver from the latest interior image at predetermined intervals (for example, every time an interior image is generated).

For example, the gaze state detection unit 24 detects an area (hereinafter referred to as an eye region) in which the driver's eyes are represented on the interior image by inputting the interior image to a classifier trained in advance so as to detect the driver's eyes from the interior image. Such identifiers are configured as a DNN with a CNN type architecture, a support vector machine or an AdaBoost classifier. Note that the gaze state detection unit 24 may detect the eye region from the interior image according to another method of detecting the eye region, such as template matching.

The gaze state detection unit 24 detects a corneal reflection image of a light source (hereinafter, referred to as a Purkinje image) and a centroid of the pupil (hereinafter, simply referred to as a pupil centroid) from the eye region for at least one of the left and right eyes of the driver represented on the interior image. At this time, the gaze state detection unit 24 detects the Purkinje image by template matching between the template of the Purkinje image and the eye region. Similarly, the gaze state detection unit 24 may detect the pupil by template matching between the template of the pupil and the eye region, and set the centroid of the region in which the detected pupil is represented as the pupil centroid. Then, the gaze state detection unit 24 determines the positional relationship between the Purkinje image and the pupil centroid, and detects the gaze direction of the driver by referring to a table representing the relationship between the positional relationship and the gaze direction of the driver. Such a table may be stored in advance in the memory 12.

Each time the gaze direction of the driver is detected, the gaze state detection unit 24 compares the gaze direction with the latest value of the azimuth from the vehicle 10 to the target vehicle to determine whether or not the driver is facing toward the target vehicle. At this time, the gaze state detection unit 24 determines that the driver is facing toward the target vehicle when the azimuth to the target vehicle is included within a predetermined angular range centered on the gaze direction. The predetermined angular range may be, for example, a range corresponding to the effective field of view (±30 to 35 degrees in the left-right direction). In a case where the target vehicle is located behind the vehicle 10, in a case where the gaze direction of the driver is included in an angular range from the driver to the room mirror or an angular range to the door mirror, the gaze state detection unit 24 may determine that the driver is facing toward the target vehicle. In this case, the gaze state detection unit 24 determines the angular range from the driver to the room mirror by referring to a table representing the relationship between the seat position of the driver sheet and the angular range. Further, the gaze state detection unit 24 can specify the sheet position by receiving a signal representing the sheet position from the driver sheet. In addition, when the target vehicle is located on the left side of the vehicle 10, the gaze state detection unit 24 may specify the angular range to the door mirror by referring to a table indicating the relationship between the seat position of the driver seat and the angular range to the door mirror on the left side. Similarly, when the target vehicle is located on the right side of the vehicle 10, the gaze state detection unit 24 may specify the angular range to the door mirror by referring to a table representing the relationship between the seat position of the driver seat and the angular range to the door mirror on the right side. Note that these tables may be stored in advance in the memory 12.

The gaze state detection unit 24 calculates, for each predetermined gaze determination period (for example, 1 to several seconds), a ratio of the number of times that the driver is determined to be facing toward the target vehicle to the total number of interior images obtained within the gaze determination period. When the ratio is equal to or larger than the gaze detection threshold (for example, 0.4 to 0.6), the gaze state detection unit 24 determines that the driver is gazing at the target vehicle in the gaze determination period.

The gaze state detection unit 24 may determine whether or not the occupant other than the driver is gazing at the target vehicle for each gaze determination period by executing the same processing as described above on the interior image. When the in-vehicle monitor camera 3 is provided individually for each seat position of the occupant, the gaze state detection unit 24 may determine whether or not the occupant at the seating position is gazing at the target vehicle based on the interior image of the in-vehicle monitor camera 3 corresponding to the seating position. In this case, for the interior image in which the eye region is not detected, the gaze state detection unit 24 may determine that there is no occupant at the seat position corresponding to the interior image, and may not detect the gaze direction and may not determine the gaze state at the seat position. In addition, in a case where a plurality of occupants are represented in one interior image obtained by one in-vehicle monitor camera 3, the gaze state detection unit 24 may detect the gaze direction of each occupant by detecting the eye region of the occupant for each region on the interior image corresponding to each seat position. Then, the gaze state detection unit 24 may determine whether or not individual occupant is gazing at the target vehicle on the basis of the detection result of the gaze direction for each occupant.

The gaze state detection unit 24 notifies the adjustment unit 25 of a determination result (hereinafter, sometimes referred to as a gaze determination result) indicating whether or not each of the driver and the occupant other than the driver is gazing at the target vehicle at each gaze determination period. Further, the gaze state detection unit 24 may notify the adjustment unit 25 of the average value of the vertical distance to the target vehicle and the average value of the relative speed in the gaze determination cycle for each gaze determination period.

The adjustment unit 25 adjusts the interruption determination condition in accordance with the gaze state for the target vehicle by the occupant of the vehicle 10. For this purpose, the adjustment unit 25 refers to the gaze determination result for the target vehicle by the driver for each gaze determination period. Further, when the gaze determination result for the target vehicle is obtained for the occupant other than the driver, the adjustment unit 25 refers to the gaze determination result for the target vehicle by the occupant other than the driver for each gaze determination period.

For example, when the gaze determination result indicating that the driver is gazing at the target vehicle continuously over a plurality of gaze determination periods is obtained, the adjustment unit 25 relaxes the interruption determination condition as the gaze duration in which the driver is determined to be gazing at the target vehicle increases. In the above example, the adjustment unit 25 decreases the distance threshold as the gaze duration becomes longer. In this case, the adjustment unit 25 may add a predetermined count value every time it is notified that the driver is determined to be gazing at the target vehicle, and relax the interruption determination condition as the sum of the count values increases. Note that the adjustment unit 25 may subtract the predetermined count value from the sum of the count values each time it is notified that the driver has determined that the driver is not gazing at the target vehicle. Alternatively, the adjustment unit 25 may reset the sum of the count values to 0 when the driver is continuously notified that the driver is not gazing at the target vehicle for a predetermined number of times. Therefore, even if the driver is temporarily paying attention to the target vehicle, the interruption determination condition is not relaxed unless the driver is currently paying attention to the target vehicle. In addition, if the driver does not pay attention to the target vehicle, a relatively strict interruption determination condition is set.

In addition, as the number of occupants determined to be gazing at the target vehicle increases, the adjustment unit 25 may relax the interruption determination condition. In this case, the adjustment unit 25 may calculate the sum of the count values for each occupant, and determine the number of occupants whose total value is equal to or larger than the predetermined gaze determination threshold as the number of occupants who are determined to be gazing at the target vehicle. This is because the driver or other occupant is expected to interrupt the target vehicle in front of the vehicle 10 as the gaze duration by the driver increases and the number of occupants being gazing at the target vehicle increases, so that even if the vehicle 10 actually decelerates due to the relaxation of the interruption determination condition, there is no sense of discomfort for the driver or other occupant.

The adjustment unit 25 may adjust the count value according to the distance to the target vehicle. For example, the adjustment unit 25 may decrease the count value in the gaze determination period as the average distance to the target vehicle is longer. As a result, the influence on the interruption determination condition when the target vehicle is far from the vehicle 10 is reduced. Therefore, as the target vehicle is closer when the occupant of the vehicle 10 is gazing at the target vehicle, the interruption determination condition is relaxed.

Further, the adjustment unit 25 may make the count value for the occupant other than the driver smaller than the count value for the driver. This is because the occupant other than the driver does not necessarily pay attention to the behavior of the target vehicle and pays attention to the target vehicle. In addition, when the sum of the count values for the driver is less than the gaze determination threshold value, that is, when the driver is not gazing at the target vehicle, the adjustment unit 25 may set the number of occupants determined to be gazing at the target vehicle for determining the interruption determination condition to 0.

Further, the adjustment unit 25 may make the count value in a case where the target vehicle is a special vehicle smaller than the count value in a case where the target vehicle is a vehicle of a type other than the special vehicle. At this time, in the case where the target vehicle is a special vehicle, the adjustment unit 25 may make the count value in the case where the warning light of the target vehicle is in the on state smaller than the count value in the case where the warning light is in the off state. This is because when the target vehicle is a special vehicle, the occupant may be gazing at the target vehicle even if the occupant is not concerned about interruption by the target vehicle.

The adjustment unit 25 notifies the determination unit 22 of the set interruption determination condition.

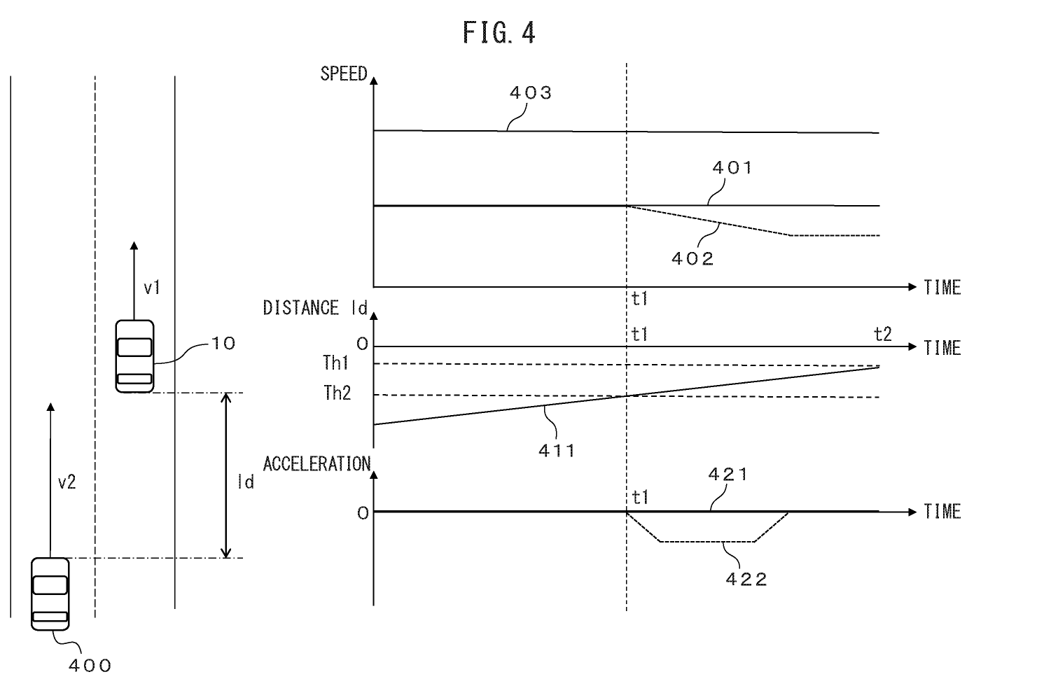

FIG. 4 is a diagram for explaining an outline of a vehicle control process according to the present embodiment. In this example, it is assumed that the target vehicle 400 traveling in the adjacent lane is trying to overtake the vehicle 10 from the left rear side of the vehicle 10. Further, three charts shown on the right side of FIG. 4 are, in order from the top, a chart representing temporal changes in the speed v1 of the vehicle 10 and the speed v2 of the target vehicle 400, a chart representing a temporal change in the vertical distance ld between the vehicle 10 and the target vehicle 400, and a chart representing a temporal change in the acceleration of the vehicle 10. In each chart, the horizontal axis represents time. The vertical axis represents speed in the top chart, the vertical distance ld in the second chart from the top, and the acceleration in the bottom chart. The acceleration having a negative value indicates that the vehicle 10 decelerates. Further, in the top chart, the graph 401 represents a temporal change in the speed v1 of the vehicle 10 when a relatively strict interruption determination condition is set, and the graph 402 represents the temporal change in the speed v1 of the vehicle 10 when a relatively relaxed interruption determination condition is set. The graph 403 represents the temporal change in the speed v2 of the target vehicle 400. Furthermore, in the second chart from the top, the graph 411 represents the temporal change of the vertical distance ld. The distance threshold Th1 corresponds to a relatively strict interruption determination condition, and the distance threshold Th2 corresponds to a relatively relaxed interruption determination condition. Furthermore, in the bottom chart, the graph 421 represents the temporal change in acceleration of the vehicle 10 when a relatively strict interruption determination condition is set, and the graph 422 represents the temporal change in acceleration of the vehicle 10 when a relatively relaxed interruption determination condition is set.

In this embodiment, the speed v2 of the target vehicle 400 is higher than the speed v1 of the vehicle 10, so that the target vehicle 400 approaches the vehicle 10 and the vertical distance ld decreases as time elapses. Then, as shown in the charts, when a relatively relaxed interruption determination condition is set, for example, when the driver is continuously gazing at the target vehicle 400, the vertical distance ld becomes equal to or smaller than the distance threshold Th1 at the time t1, and the deceleration of the vehicle 10 is started, and consequently, the speed v1 of the vehicle 10 is decreased. Incidentally, with this deceleration, after the time t1, the vertical distance ld becomes sharper than the graph 411, and the target vehicle 400 overtakes the vehicle 10 at an early stage. On the other hand, when a relatively strict interruption determination condition is set, for example, when the driver does not gaze at the target vehicle 400 at all, the vertical distance ld does not become equal to or smaller than the distance threshold Th2 until the time t2. Therefore, the deceleration of the vehicle 10 is not started until the time t2, and the speed v1 of the vehicle 10 is also kept constant. As a result, when the vehicle that the driver is not gazing at approaches from behind, the vehicle 10 is prevented from automatically starting to decelerate at a timing that the driver does not intend.

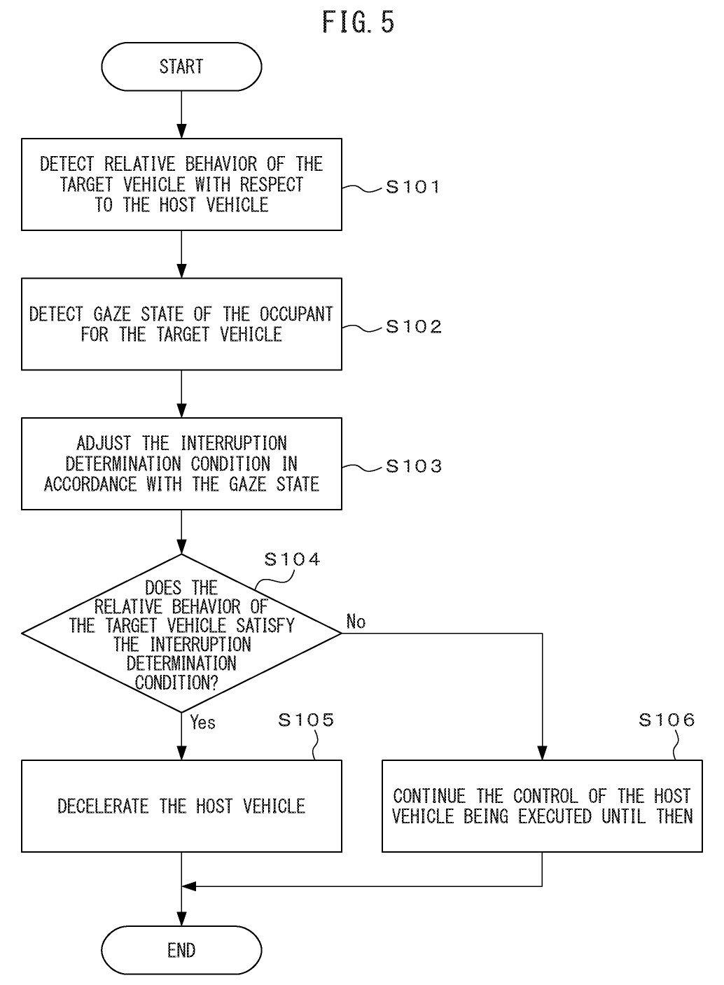

FIG. 5 is an operation flowchart of a vehicle control process executed by the processor 13. The processor 13 may execute the vehicle control process according to the following operation flowchart.

The other vehicle detecting unit 21 detects the target vehicle traveling in an adjacent lane adjacent to the host lane on which the host vehicle (i.e., the vehicle 10) travels, and detects the relative behavior of the target vehicle with respect to the vehicle 10 (step S101). The gaze state detector 24 detects the gaze state for the target vehicle by the occupant of the vehicle 10 (step S102). Then, the adjustment unit 25 adjusts the interruption determination condition in accordance with the gaze state for the target vehicle (step S103).

The determination unit 22 determines whether or not the relative behavior of the target vehicle with respect to the vehicle 10 satisfies the interruption determination condition (step S104). When the interruption determination condition is satisfied (Yes in step S104), the control unit 23 executes deceleration control of the vehicle 10 so that the distance between the target vehicle and the vehicle 10 is maintained at a predetermined distance or more even when the target vehicle moves to the host lane in front of the vehicle 10 (step S105). On the other hand, when the interruption determination condition is not satisfied (No in step S104), the control unit 23 continues the control of the vehicles 10 until then (step S106). After step S105 or step S106, the processor 13 terminates the vehicle control process.

As described above, the vehicle control device adjusts the interruption determination condition for starting the deceleration control of the host vehicle in preparation for the interruption of the target vehicle in accordance with the gaze state of the occupant of the host vehicle with respect to the target vehicle traveling in the adjacent lane adjacent to the host lane. Therefore, the vehicle control device can make it difficult for the occupant of the host vehicle to feel anxiety with respect to the behavior of the host vehicle when there is another vehicle that may cut in front of the host vehicle.

The computer program for achieving the functions of the processor 13 of the ECU 4 according to the above-described embodiment or modification may be provided in a form recorded on a computer-readable portable recording medium such as a semiconductor memory, a magnetic recording medium, or an optical recording medium.

As described above, a skilled person can make various modifications according to the embodiment within the scope of the present disclosure.

What is claimed is:

1. A vehicle control device comprising:
a processor configured to:
detect another vehicle traveling on an adjacent lane adjacent to a host lane on which a host vehicle travels based on an exterior sensor signal representing a predetermined area around the host vehicle,
detect a relative behavior of the other vehicle with respect to the host vehicle,
determine whether or not the relative behavior of the other vehicle satisfies a predetermined interruption determination condition,
decelerate the host vehicle when the behavior satisfies the interruption determination condition,
detect a gaze direction of one or more occupants of the host vehicle based on an interior image representing an interior of the host vehicle,
detect a gaze state of the occupants with respect to the other vehicle based on a detection result of the gaze direction; and
adjust the interruption determination condition according to the gaze state.

2. The vehicle control device according to claim 1, wherein the processor relaxes the interruption determination condition as a duration in which a driver among the occupants is gazing at the other vehicle becomes longer.

3. The vehicle control device according to claim 1, wherein the processor relaxes the interruption determination condition as the number of the occupants of the host vehicle who are gazing at the other vehicle increases.

4. A vehicle control method includes:
detecting another vehicle traveling on an adjacent lane adjacent to a host lane on which a host vehicle travels based on an exterior sensor signal representing a predetermined area around the host vehicle;
detecting a relative behavior of the other vehicle with respect to the host vehicle;
detecting the relative behavior of the other vehicle relative to the host vehicle;
determining whether or not the relative behavior of the other vehicle satisfies a predetermined interruption determination condition;
decelerating the host vehicle when the behavior satisfies the interruption determination condition;
detecting a gaze direction of one or more occupants of the host vehicle based on an interior image representing an interior of the host vehicle;
detecting a gaze state of the occupants with respect to the other vehicle based on a detection result of the gaze direction; and
adjusting the interruption determination condition according to the gaze state.

5. A non-transitory recording medium that stores a computer program for vehicle control, the computer program causing a processor mounted on a host vehicle to execute a process comprising:
detecting another vehicle traveling on an adjacent lane adjacent to a host lane on which the host vehicle travels based on an exterior sensor signal representing a predetermined area around the host vehicle;
detecting a relative behavior of the other vehicle with respect to the host vehicle;
detecting the relative behavior of the other vehicle relative to the host vehicle;
determining whether or not the relative behavior of the other vehicle satisfies a predetermined interruption determination condition;
decelerating the host vehicle when the behavior satisfies the interruption determination condition;
detecting a gaze direction of one or more occupants of the host vehicle based on an interior image representing an interior of the host vehicle;
detecting a gaze state of the occupants with respect to the other vehicle based on a detection result of the gaze direction; and
adjusting the interruption determination condition according to the gaze state.
